(19) United States
(12) Patent Application Publication
(10) Pub. No.: US 2009/0174616 A1
(43) Pub. Date: Jul. 9, 2009

(54) FRACTAL ANTENNA FOR VEHICLE

(76) Inventors: Jin-Ho KIM, Bucheon (KR); Dong-Won Lee, Gunpo (KR)

Correspondence Address: WILLIAMS MULLEN, 222 CENTRAL PARK AVENUE, SUITE 1700, VIRGINIA BEACH, VA, 23462, US

(21) Appl. No.: 12/183,060

(22) Filed: Jul. 30, 2008

(30) Foreign Application Priority Data
Jan. 3, 2008 (KR) 10-2008-000519

(51) Int. Cl. H01Q 1/38; H01Q 1/32; H01Q 1/42

(52) U.S. Cl. 343/711; 343/700 MS; 343/872

(57) ABSTRACT

Disclosed herein is a fractal antenna for a vehicle. First and second radiation elements are downwardly inclined from an apex ridge, and disposed opposite each other on the left and right sides inside a radome for protecting the antenna. First and second parasitic elements are formed in an inner space which is formed by the first and second radiation elements. Further, the first and second parasitic elements are disposed to be parallel to and spaced apart from the respective first and second radiation elements at regular intervals, are downwardly inclined from an apex ridge, and are disposed opposite each other on the left and right sides. The first and second radiation elements are respectively formed on part of the upper surface of a first substrate and part of the upper surface of a second substrate in patterns each having a predetermined shape.

### BACKGROUND OF THE INVENTION

1. Field of the Invention

The present invention relates generally to a fractal antenna for a vehicle, and more particularly, to a fractal antenna for a vehicle in which parasitic elements are disposed in an inner space formed by radiation elements, thereby generating broadband resonance frequencies, two radiation elements are disposed opposite each other on the left and right sides, thereby providing an omnidirectional antenna, and which uses a pattern having a fractal structure, so that space efficiency is improved, thereby reducing the size of the antenna.

2. Description of the Related Art

Generally, micro-strip patch antennas are currently most widely used as antennas used in land broadcasting, satellite broadcasting, and communication. However, such a micro-strip patch antenna has problems in that the efficiency thereof is considerably low, and the active management of bandwidth is difficult because the bandwidth is narrow, so that the center frequency of the bandwidth changes depending on variations in the surrounding environment.

Further, a conventional antenna has been manufactured using a method of printing an antenna pattern on part of a printed circuit board, on which a signal transmission/reception circuit and a data processing circuit are printed. In the case in which an antenna pattern is printed on a printed circuit board and an antenna is integrally provided, radiation patterns are not regular in all directions. Therefore, a problem occurs in that radiation efficiency for a specific direction is low, so that reception sensitivity is decreased. In order to perform mobile communication, such as the reception of Digital Multimedia Broadcasting (DMB) broadcasts and Amplitude Modulation/Frequency Modulation (AM/FM) broadcasts, communication must be performed in all directions, and thus it is considerably important for an antenna to have good omnidirectional characteristics in two dimensions.

In addition, when signals are received having a frequency bandwidth of which the central frequency is 200 MHz, such as DMB signals, the electrical length of a monopole antenna is generally 37.6 cm. The length of an AM/FM broadcasting antenna, which uses a lower frequency band than the DMB broadcasting antenna, is longer than that of the DMB broadcasting antenna. However, an antenna which has been conventionally used and has the appearance of a protruding structure, has problems in that it is undesirable in safety and appearance, it is inconvenient, and may be damaged when a vehicle is washed.

Therefore, a realistic, practical solution, which can reduce the size of an antenna by acquiring the electrical length of a radiation element in a limited space, has good omnidirectional characteristics so as to be suitable to receive DMB and AM/FM broadcasts, and which can realize broadband characteristics by optimizing the performance of the antenna, is seriously required.

### SUMMARY OF THE INVENTION

Accordingly, the present invention has been made keeping in mind the above problems occurring in the prior art, and an object of the present invention is to provide a fractal antenna for a vehicle, in which first and second parasitic elements are disposed in an inner space formed by first and second radiation elements, so that the radiation elements and the parasitic elements are connected to each other in a coupling fashion, with the result that compensation is performed on a capacitance value, thereby generating broadband resonance frequencies.

Another object of the present invention is to provide a fractal antenna for a vehicle, in which the first and second radiation elements are disposed opposite each other on left and right sides, thereby providing an omnidirectional antenna, the signal attenuation of which is small in all directions.

Still another object of the present invention is to provide a fractal antenna for a vehicle, which uses a fractal structure pattern, so that space efficiency is improved, thereby providing an antenna that is further reduced in size.

In order to accomplish the above object, the present invention provides a fractal antenna for a vehicle, including first and second radiation elements downwardly inclined from an apex ridge, and disposed opposite each other on the left and right sides inside a radome for protecting the antenna; and first and second parasitic elements formed in an inner space formed by the first and second radiation elements, disposed to be parallel to and spaced apart from the respective first and second radiation elements at regular intervals, downwardly inclined from an apex ridge, and disposed opposite each other on the left and right sides.

In order to accomplish the above object, the present invention provides a fractal antenna for a vehicle including four substrates, that is, two pairs of substrates, a first pair of substrates being downwardly inclined from an apex ridge and disposed opposite each other on the left and right sides, and a second pair of substrates being downwardly inclined from an apex ridge and disposed opposite each other on the left and right sides; pattern units formed on the respective outer surfaces of the substrates; and a feed unit configured to apply signals to the pattern units.

In order to accomplish the above object, the present invention provides a fractal antenna for a vehicle including four substrates, that is, two pairs of substrates, a first pair of substrates being downwardly inclined from an apex ridge and disposed opposite each other on the left and right sides, and a second pair of substrates being downwardly inclined from an apex ridge and disposed opposite each other on the left and right sides; pattern units configured to have respective predetermined shapes, and formed on the respective outer surfaces of the substrates; a feed unit configured to apply signals to the pattern units; and a radome configured to protect the pattern units; wherein the substrates are disposed inside the radome so that a central axis between the first pair of substrates, which are downwardly inclined from an apex ridge and are disposed opposite each other on the left and right sides, and a central axis between the second pair of substrates, which are downwardly inclined from an apex ridge and are disposed opposite each other on the left and right sides, are perpendicular to the mounting surface of the vehicle.

Therefore, the present invention has an advantage in that the first and second parasitic elements are disposed in an inner space formed by the first and second radiation elements, so that the radiation elements and the parasitic elements are connected to each other in a coupling fashion, with the result that compensation is performed on a capacitance value, thereby generating broadband resonance frequencies.

Further, the fractal antenna for a vehicle according to the present invention provides an omnidirectional antenna in which the first and second radiation elements are disposed opposite each other on the left and right sides, so that signal attenuation is small in all directions.

In addition, the fractal antenna for a vehicle according to the present invention uses a fractal structure pattern, so that space efficiency is improved, thereby providing an antenna that is further reduced in size.

### BRIEF DESCRIPTION OF THE DRAWINGS

The above and other objects, features and other advantages of the present invention will be more clearly understood from the following detailed description, taken in conjunction with the accompanying drawings, in which:

FIG. 1 is a perspective view showing a fractal antenna for a vehicle according to an embodiment of the present invention;

FIG. 2 is a cross-sectional view showing the fractal antenna for a vehicle according to the embodiment of the present invention;

FIG. 3 is a cubic view showing the fractal antenna for a vehicle according to the embodiment of the present invention;

FIG. 4 is a plan view showing the fractal antenna for a vehicle according to the embodiment of the present invention;

FIG. 5 shows examples of typical fractal structures;

FIG. 6 shows the structure of a radiation element of an AM/FM broadcasting fractal antenna for a vehicle according to an embodiment of the present invention;

FIG. 7 shows the characteristics of an antenna Voltage Standing Wave Ratio (VSWR) according to the embodiment of the present invention; and

FIG. 8 shows the characteristics of an antenna radiation pattern according to the embodiment of the present invention.

### DESCRIPTION OF THE PREFERRED EMBODIMENTS

Hereinafter, preferred embodiments of the present invention will be described in detail with reference to the attached drawings.

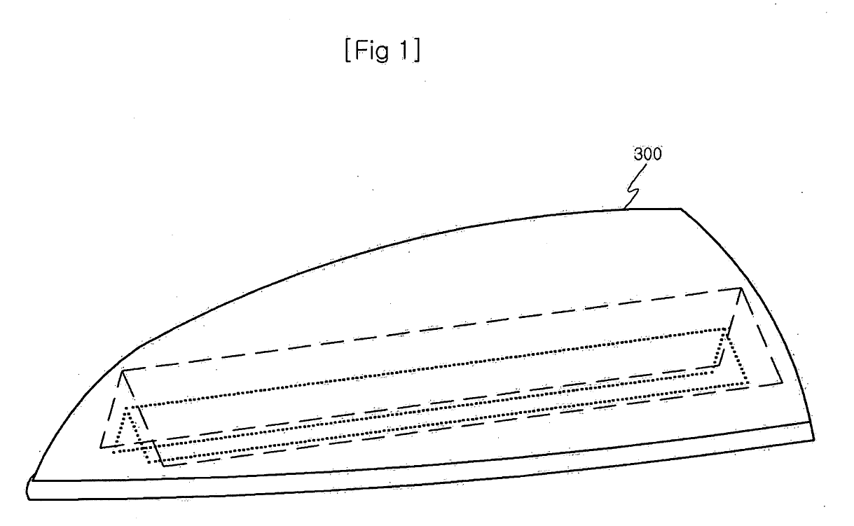

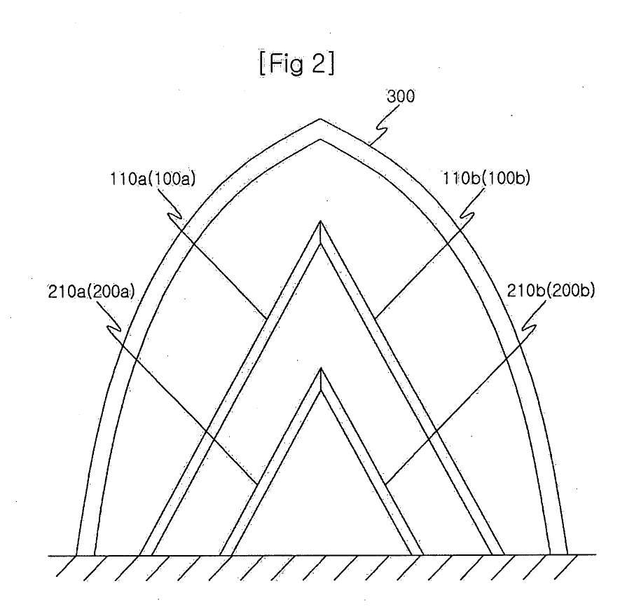

FIG. 1 is a perspective view showing a fractal antenna for a vehicle according to an embodiment of the present invention, and FIG. 2 is a cross-sectional view showing the fractal antenna for a vehicle according to the embodiment of the present invention.

The fractal antenna for a vehicle according to the embodiment of the present invention includes first and second radiation elements 100a and 100b and first and second parasitic elements 200a and 200b.

In further detail, as shown in FIGS. 1 and 2, the first and second radiation elements 100a and 100b and the first and second parasitic elements 200a and 200b are installed inside a radome 300, which protects the antenna and is installed upright on the mounting surface of a vehicle.

Inside the radome 300, the first and second radiation elements 100a and 100b are downwardly inclined from an apex ridge and are disposed opposite each other on the left and right sides. Further, in an inner space formed by the first and second radiation elements 100a and 100b, the first and second parasitic elements 200a and 200b are disposed to be parallel to and spaced apart from the respective first and second radiation elements 100a and 100b at regular intervals, are downwardly inclined from an apex ridge, and are disposed opposite each other on the left and right sides.

A central axis between the first and second radiation elements 100a and 100b, which are downwardly inclined from the apex ridge and are disposed opposite each other on the left and right sides, and a central axis between the first and second parasitic elements 200a and 200b, which are downwardly inclined from the apex ridge and are disposed opposite each other on the left and right sides, are disposed such that they are perpendicular to the mounting surface of the vehicle.

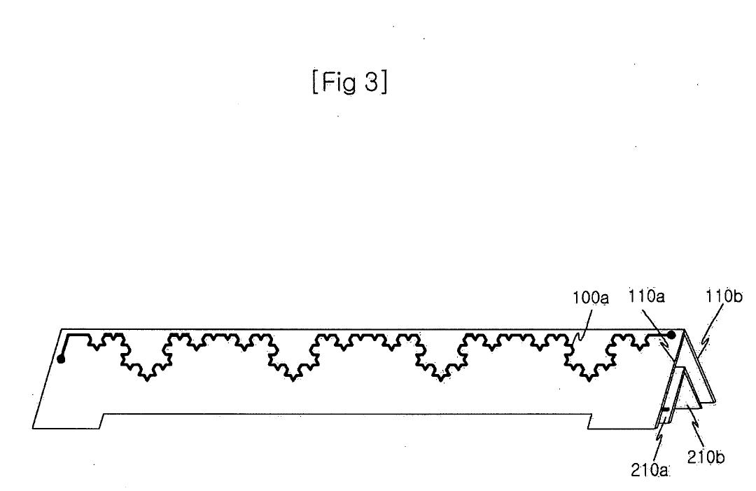

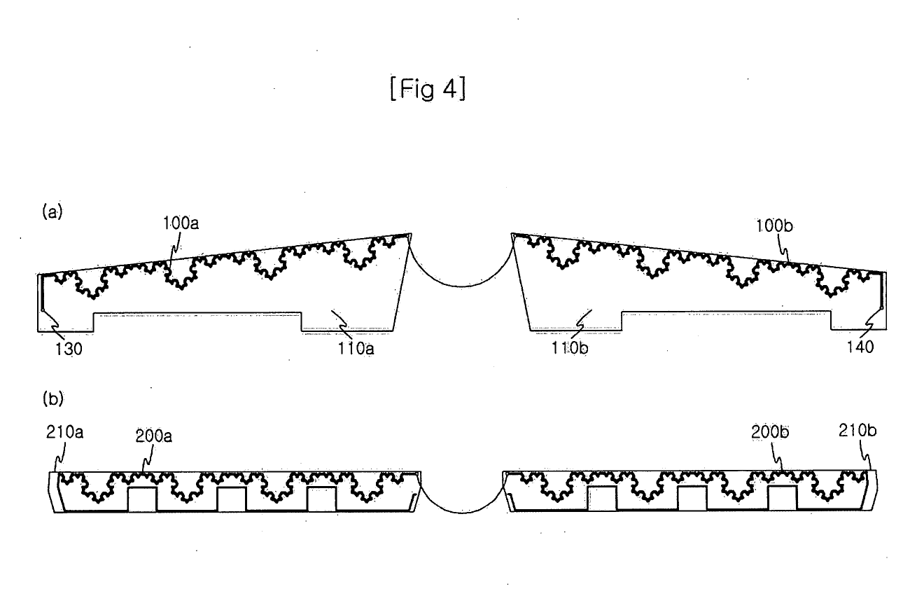

FIG. 3 is a cubic view showing the fractal antenna for a vehicle according to the embodiment of the present invention, and FIG. 4 is a plan view showing the fractal antenna for a vehicle according to the embodiment of the present invention.

As shown in FIGS. 3 and 4, the first and second radiation elements 100a and 100b are respectively formed on part of the upper surface of one side of a first substrate 110a and part of the upper surface of one side of a second substrate 110b in patterns each having a predetermined shape.

Each of the first and second substrates 110a and 110b is formed to have a predetermined size. Various types of modifications can be performed on the first and second substrates 110a and 110b depending on the shape of the radome 300, and the materials of the first and second substrates 110a and 110b can be easily changed to, for example, epoxy, plastics, Flame Retardant 4 (FR4), and Teflon for the use thereof.

The first and second radiation elements 100a and 100b are respectively formed on part of the upper surface of one side of the first substrate 110a and part of the upper surface of one side of the second substrate 110b in patterns each having a predetermined shape. In this embodiment, the first and second radiation elements 100a and 100b are each formed in such a way that a Koch curve fractal is periodically iterated.

An antenna having a fractal structure can be considerably smaller without decreasing its performance. Further, the fractal structure is used to obtain a multi-frequency band and applied to an antenna in order to increase the bandwidth around each frequency using the principle of self-similarity.

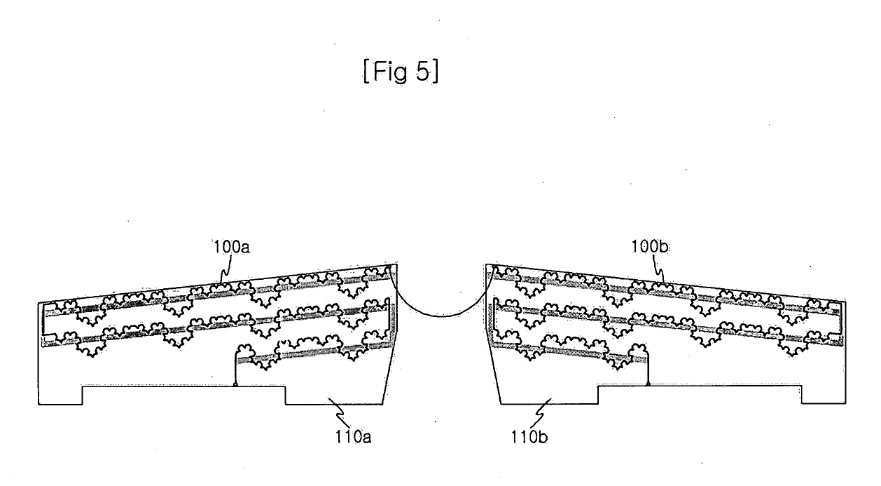

The self-similarity for an antenna shape can be obtained by performing flexion deformity or molding on a surface, by forming a fractal shape. In FIG. 5, various types of fractals are shown as examples. The fractal antenna can be formed using fractal shapes having various structures, such as a Sierpinski gasket, a Sierpinski carpet, a Minkovski patch, a Mandelbrot tree, a Koch curve, and a Koch island.

Although the Koch curve shape is employed in the embodiments of the present invention, the antenna according to the present invention can be formed using various fractal shapes, as described above.

A feed unit 130 is formed on one end of the first radiation element 100a. The feed unit 130 supplies power to the first and second radiation elements 100a and 100b.

An open end 140 is formed on one end of the second radiation element 100a.

The first and second radiation elements 100a and 100b are electrically connected to each other. Since the first and second radiation elements 100a and 100b are electrically connected to each other, the total length of the fractal antenna for a vehicle according to the present invention is the length of the pattern of the first radiation element 100a added to the length of the pattern of the second radiation element 100b.

A basic resonant frequency is adjusted based on the total length and width of the respective patterns of the first radiation element 100a and the second radiation element 100b. The total length of the patterns of the first radiation element 100a and the second radiation element 100b determines the resonant frequency, and the width of the patterns of the first radiation element 100a and the second radiation element 100b determines the resonance width of the resonant frequency.

The fractal antenna for a vehicle according to the present invention is operated in a DMB broadcast reception band or an AM/FM broadcast reception band based on the total length of the patterns which form the first and second radiation elements 100a and 100b.

In this embodiment, if the total length of the patterns of the first radiation element 100a and the second radiation element 100b is 38±2 cm, the antenna has the resonance characteristics of a band (174 to 216 MHz) that is suitable for DMB broadcast reception. In this case, each of the first and second radiation elements 100a and 100b, which are formed in a fractal shape, has a basic period length of 2 cm and is formed in a Koch curve shape having four periods together with four scales. The length of each of the patterns of the first and second radiation elements 100a and 100b is approximately 18.96 cm, and the total length of the first and second radiation elements 100a and 100b is 37.94 cm.

In this embodiment, if the total length of the patterns of the first radiation element 100a and second radiation element 100b is 95±2 cm, the antenna has the resonance characteristics of a band (88 to 108 MHz) that is suitable for FM broadcast reception. In this case, each of the first and second radiation elements 100a and 100b, which are formed in a fractal shape, has a basic period length of 2 cm and is formed in a Koch curve shape having ten periods together with four scales. The length of each of the patterns of the first and second radiation elements 100a and 100b is approximately 47.4 cm, and the total length of the first and second radiation elements 100a and 100b is approximately 94.8 cm. In addition, the first radiation element 100a and the second radiation element 100b generate resonance frequencies in an AM band (150 to 1750 KHz) using a buffer and amplifier by matching input impedance with high impedance.

The numerical values for the length of the patterns of the radiation elements are mentioned in the above-described embodiment by way of example, but the present invention is not limited thereto.

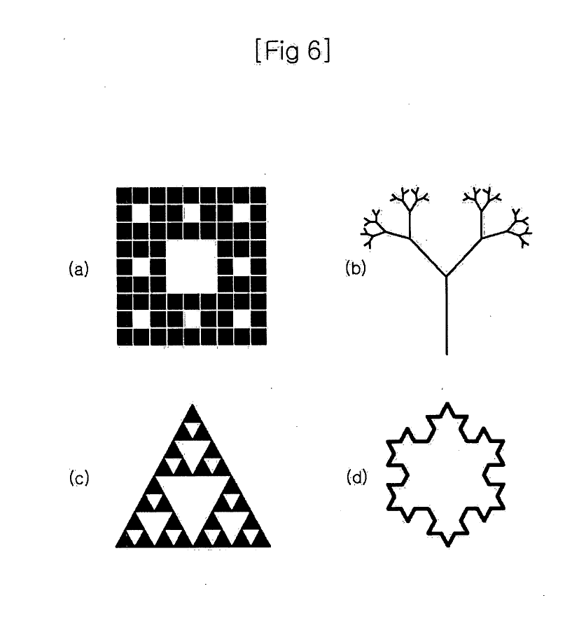

The pattern unit of an antenna such as an AM/FM broadcasting antenna, which uses a low frequency band, is long. As shown in FIG. 6, when the lengths of the first and second radiation elements 100a and 100b are respectively longer than the lengths of the first and second substrates 110a and 110b, the first and second radiation elements 100a and 100b are formed so as to be curved in the form of a meander line structure within the respective first and second substrates 110a and 110b, so that a single pattern is formed without being cut off.

The first and second parasitic elements 200a and 200b are respectively formed on part of the upper surface of one side of a third substrate 210a and part of the upper surface of one side of a fourth substrate 210b in patterns each having a predetermined shape, each of the third and fourth substrates being formed to have a predetermined size. The first and second parasitic elements 200a and 200b are electrically connected to each other.

Like the first and second radiation elements 100a and 100b, the first and second parasitic elements 200a and 200b are formed in such a way that a Koch curve fractal is periodically iterated.

The first radiation element 100a is connected to the first parasitic element 200a in a coupling fashion, and the second radiation element 100b is connected to the second parasitic element 200b in a coupling fashion, so that compensation is performed on a capacitance value ‘C’, thereby generating broadband resonance frequencies.

In an inner space, which is formed in such a way that the first and second radiation elements 100a and 100b are downwardly inclined from an apex ridge and are disposed opposite each other on the left and right sides, the first and second parasitic elements 200a and 200b are disposed to be parallel to and spaced apart from the respective first and second radiation elements 100a and 100b, and are disposed opposite each other on the left and right sides. In this embodiment of the present invention, the first and second parasitic elements 200a and 200b and the first and second radiation elements 100a and 100b are disposed while maintaining an optimized separation therebetween of 3 mm. The locations of the first and second parasitic elements 200a and 200b determine the amount of coupling.

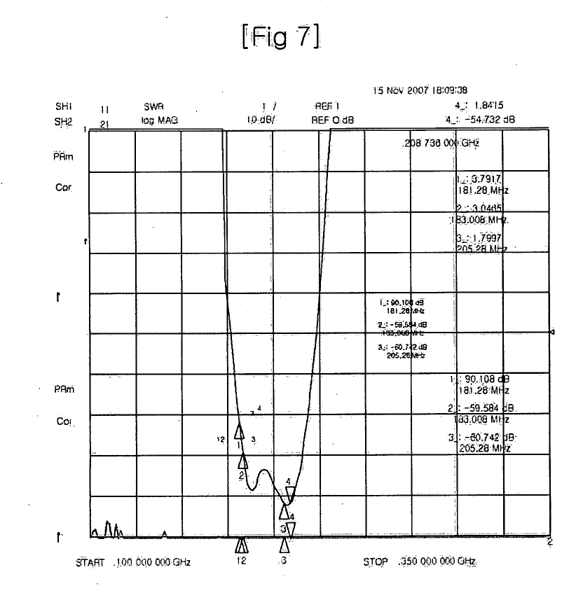

FIG. 7 is a view showing the characteristics of an antenna VSWR according to the embodiment of the present invention.

As shown in FIG. 7, the frequency band of the fractal antenna for a vehicle according to the present invention is expanded by approximately 20 MHz, compared to the characteristics of a general-purpose micro-strip patch antenna.

Since the first and second radiation elements 100a and 100b are downwardly inclined from an apex ridge and are disposed opposite each other on the left and right sides, the fractal antenna for a vehicle has an omnidirectional radiation pattern.

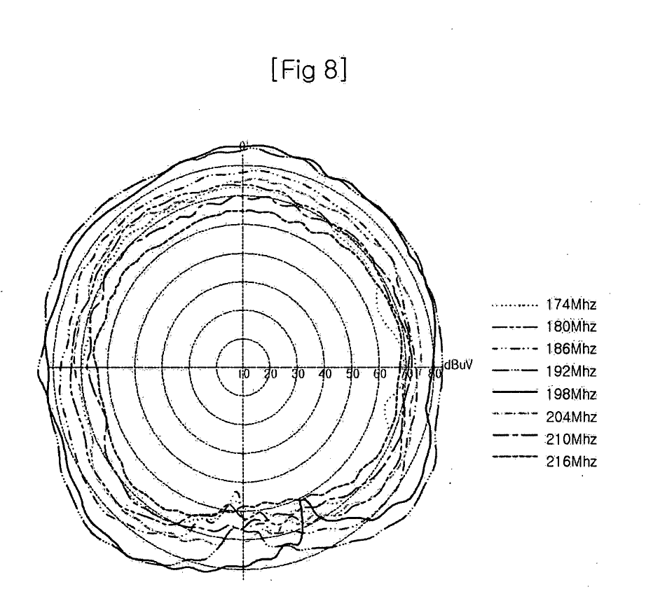

FIG. 8 is a view showing the characteristics of an antenna radiation pattern according to the embodiment of the present invention.

As shown in FIG. 8, the fractal antenna for a vehicle according to the present invention provides an omnidirectional antenna, the signal attenuation of which is small in all directions.

A fractal antenna for a vehicle according to another embodiment of the present invention includes substrates 110a and 110b which are downwardly inclined from an apex ridge and are disposed opposite each other on the left and right sides (for an example, in a ‘A’ shape); substrates 210a and 210b which are downwardly inclined from an apex ridge and are disposed opposite each other on the left and right sides in an inner space formed by the substrates 110a and 110b and having the same shape as the substrates 110a and 110b; pattern units 100a, 100b, 200a, and 200b which have predetermined shapes and are formed on the respective outer surfaces of the substrates 110a, 110b, 210a, and 210b; and a feed unit 130 which applies signals to the four pattern units 100a, 100b, 200a, and 200b.

In further detail, the substrates 110a and 110b are downwardly inclined from the apex ridge and are disposed opposite each other on the left and right sides, and the substrates 210a and 210b are downwardly inclined from the apex ridge and are disposed opposite each other on the left and right sides. The substrates 110a, 110b, 210a, and 210b are disposed inside the radome 300, which protects the antenna, so that a central axis between the substrates 110a and 110b and a central axis between the substrates 210a and 210b is perpendicular to the mounting surface of the vehicle.

The substrates 110a, 110b, 210a, and 210b include outwardly disposed first and second substrates 110a and 110b and inwardly disposed third and fourth substrates 210a and 210b.

The pattern units 100a, 100b, 200a, and 200b include the first and second radiation elements 100a and 100b, which are formed on the respective first and second substrates 110a and 110b in such a way that a Koch curve fractal is periodically iterated, and are configured to radiate electromagnetic waves, and include the first and second parasitic elements 200a and 200b, which are formed on the respective third and fourth substrates 210a and 210b in such a way that a Koch curve fractal is periodically iterated, and are connected to the respective first and second radiation elements 100a and 100b in a coupling fashion.

The basic resonant frequency is adjusted based on the total length and width of the patterns, which form the first and second radiation elements 100a and 100b.

The fractal antenna for a vehicle according to the present invention is operated in a DMB broadcast reception band or an AM/FM broadcast reception band based on the total length of the patterns which form the first and second radiation elements 100a and 100b.

When the lengths of the first and second radiation elements 100a and 100b, formed in the fractal structure patterns, are longer than the respective lengths of the first and second substrates 110a and 110b, the first and second radiation elements 100a and 100b are formed so as to be curved in the form of a meander line structure.

A fractal antenna for a vehicle according to a further embodiment of the present invention includes substrates 110a and 110b, which are downwardly inclined from an apex ridge and are disposed opposite each other on the left and right sides; substrates 210a and 210b, which are downwardly inclined from an apex ridge and are disposed opposite each other on the left and right sides in an inner space formed by the substrates 110a and 110b and having the same shape as the substrates 110a and 110b; pattern units 100a, 100b, 200a, and 200b, which have predetermined shapes and are formed on the respective outer surfaces of the substrates 110a, 110b, 210a, and 210b; a feed unit 130, which applies signals to the pattern units 100a, 100b, 200a, and 200b; and a radome 300, which protects the pattern units 100a, 100b, 200a, and 200b. The substrates 110a, 110b, 210a, and 210b are disposed inside the radome 300 so that a central axis between the substrates 110a and 110b, which are downwardly inclined from the apex ridge and are disposed opposite each other on the left and right sides, and a central axis between the substrates 210a and 210b, which are downwardly inclined from the apex ridge and are disposed opposite each other on the left and right sides, is perpendicular to the mounting surface of the vehicle.

The operations and configurations of the fractal antenna for a vehicle according to this embodiment of the present invention are almost the same as those of the fractal antenna for a vehicle according to the second embodiment, and only the fact that the radome 300 for protecting the patterns 100a, 100b, 200a, and 200b is further included is different from the fractal antenna for a vehicle according to the second embodiment.

Therefore, the present invention has an advantage in that the first and second parasitic elements 200a and 200b are disposed in an inner space formed by the first and second radiation elements 100a and 100b, so that the radiation elements and the parasitic elements are connected to each other in a coupling fashion, with the result that compensation is performed on a capacitance value ‘C’, thereby generating broadband resonance frequencies.

Further, the fractal antenna for a vehicle according to the present invention provides an omnidirectional antenna in which the first and second radiation elements 100a and 100b are disposed opposite each other on the left and right sides, so that signal attenuation is small in all directions.

In addition, the fractal antenna for a vehicle according to the present invention uses a fractal structure pattern, so that space efficiency is improved, thereby providing an antenna of reduced size.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fractal antenna for a vehicle, comprising:
first and second radiation elements downwardly inclined from an apex ridge and disposed opposite each other on left and right sides inside a radome for protecting the antenna; and
first and second parasitic elements formed in an inner space formed by the first and second radiation elements, disposed to be parallel to and spaced apart from the respective first and second radiation elements at regular intervals, downwardly inclined from an apex ridge, and disposed opposite each other on left and right sides.

2. The fractal antenna for a vehicle as set forth in claim 1, wherein:
the first and second radiation elements are respectively formed on part of an upper surface of one side of a first substrate and part of an upper surface of one side of a second substrate in patterns each having a predetermined shape, each of the first and second substrates being formed to have a predetermined size; and
the first and second radiation elements are electrically connected to each other.

3. The fractal antenna for a vehicle as set forth in claim 2, wherein:
the first radiation element is provided with a feed unit configured to apply signals at one end thereof; and
the second radiation element is provided with an open end at one end thereof.

4. The fractal antenna for a vehicle as set forth in claim 2, wherein the patterns of the first and second radiation elements each having the predetermined shape are each formed in such a way that a Koch curve fractal is periodically iterated.

5. The fractal antenna for a vehicle as set forth in claim 2, wherein the first and second radiation elements are downwardly inclined from the apex ridge and are disposed opposite each other on the left and right sides.

6. The fractal antenna for a vehicle as set forth in claim 2, wherein a basic resonant frequency is adjusted based on the total length and width of the patterns, which form the first and second radiation elements.

7. The fractal antenna for a vehicle as set forth in claim 6, wherein the fractal antenna is operated in a Digital Multimedia Broadcasting (DMB) broadcast reception band or an Amplitude Modulation/Frequency Modulation (AM/FM) broadcast reception band based on the total length of the patterns, which form the first and second radiation elements.

8. The fractal antenna for a vehicle as set forth in claim 4, wherein the first and second radiation elements are formed so as to be curved in a meander line structure when the lengths of fractal structure patterns, which form the first and second radiation elements, are longer than respective lengths of the first and the second substrates.

9. The fractal antenna for a vehicle as set forth in claim 1, wherein:
the first and second parasitic elements are respectively formed on part of an upper surface of one side of a third substrate and part of an upper surface of one side of a fourth substrate in patterns each having a predetermined shape, each of the third and fourth substrates being formed to have a predetermined size; and
the first and second parasitic elements are electrically connected to each other.

10. The fractal antenna for a vehicle as set forth in claim 9, wherein the first parasitic element is connected to the first radiation element in a coupling fashion, and the second parasitic element is connected to the second radiation element in a coupling fashion, thereby generating broadband resonant frequencies.

11. The fractal antenna for a vehicle as set forth in claim 9, wherein the patterns of the first and second parasitic elements each having the predetermined shape are each formed in such a way that the a Koch curve fractal is periodically iterated.

12. The fractal antenna for a vehicle as set forth in claim 1, wherein:
the first and second radiation elements are respectively formed on part of an upper surface of one side of a first substrate and part of an upper surface of one side of a second substrate in patterns each having a predetermined shape, each of the first and second substrates being formed to have a predetermined size and the first and second radiation elements being electrically connected to each other; and
the first and second parasitic elements are respectively formed on part of an upper surface of one side of a third substrate and part of an upper surface of one side of a fourth substrate in patterns each having a predetermined shape, each of the third and fourth substrates being formed to have a predetermined size and the first and second parasitic elements being electrically connected to each other.

13. The fractal antenna for a vehicle as set forth in claim 1, wherein a central axis between the first and second radiation elements, which are downwardly inclined from the apex ridge and are disposed opposite each other on the left and right sides, and a central axis between the first and second parasitic elements, which are downwardly inclined from the apex ridge and are disposed opposite each other on the left and right sides, are disposed upright so that the central axes are perpendicular to a mounting surface of the vehicle.

14. A fractal antenna for a vehicle comprising:
four substrates including two pairs of substrates, a first pair of substrates being downwardly inclined from an apex ridge and disposed opposite each other on left and right sides, and a second pair of substrates being downwardly inclined from an apex ridge and disposed opposite each other on left and right sides;
pattern units formed on respective outer surfaces of the substrates; and
a feed unit configured to apply signals to the pattern units.

15. The fractal antenna for a vehicle as set forth in claim 14, wherein the four substrates, the pattern units, and the feed unit are disposed inside a radome for protecting the antenna so that a central axis between the first pair of substrates, which are downwardly inclined from the apex ridge and are disposed opposite each other on the left and right sides, and a central axis between the second pair of substrates, which are downwardly inclined from the apex ridge and are disposed opposite each other on the left and right sides, are perpendicular to a mounting surface of the vehicle.

16-20. (canceled)

21. The fractal antenna for a vehicle as set forth in claim 14, wherein:
the first pair of substrates comprise outwardly disposed first and second substrates and the second pair of substrates comprise inwardly disposed third and fourth substrates; and
the pattern units comprise first and second radiation elements, which are formed on the respective first and second substrates in such a way that a Koch curve fractal is periodically iterated, and are configured to radiate electromagnetic waves, and first and second parasitic elements, which are formed on the respective third and fourth substrates in such a way that a Koch curve fractal is periodically iterated and are connected to the respective first and second radiation elements in a coupling fashion.

22. The fractal antenna for a vehicle as set forth in claim 21, wherein a basic resonant frequency is adjusted based on a total length and a width of the patterns, which form the first and second radiation elements.

23. The fractal antenna for a vehicle as set forth in claim 22, wherein the fractal antenna is operated in a DMB broadcast reception band or an AM/FM broadcast reception band based on the total length of the patterns, which form the first and second radiation elements.

24. The fractal antenna for a vehicle as set forth in claim 21, wherein the first and second radiation elements are formed so as to be curved in a meander line structure when the lengths of fractal structure patterns, which form the first and second radiation elements, are longer than respective lengths of the first and the second substrates.

25. A fractal antenna for a vehicle comprising:
four substrates including two pairs of substrates, a first pair of substrates being downwardly inclined from an apex ridge and disposed opposite each other on left and right sides, and a second pair of substrates being downwardly inclined from an apex ridge and disposed opposite each other on left and right sides;
pattern units configured to have respective predetermined shapes, and formed on respective outer surfaces of the substrates;
a feed unit configured to apply signals to the pattern units; and
a radome configured to protect the pattern units;
wherein the four substrates are disposed inside the radome so that a central axis between the first pair of substrates, which are downwardly inclined from an apex ridge and are disposed opposite each other on left and right sides, and a central axis between the second pair of substrates, which are downwardly inclined from an apex ridge and are disposed opposite each other on the left and right sides, are perpendicular to a mounting surface of the vehicle.

26. The fractal antenna for a vehicle as set forth in claim 25, wherein:
the first pair of substrates comprise outwardly disposed first and second substrates and the second pair of substrates comprise inwardly disposed third and fourth substrates; and
the pattern units comprise first and second radiation elements, which are formed on the respective first and second substrates in such a way that a Koch curve fractal is periodically iterated, and are configured to radiate electromagnetic waves, and first and second parasitic elements, which are formed on the respective third and fourth substrates in such a way that a Koch curve fractal is periodically iterated and are connected to the respective first and second radiation elements in a coupling fashion.

27. The fractal antenna for a vehicle as set forth in claim 26, wherein a basic resonant frequency is adjusted based on a total length and a width of the patterns, which form the first and second radiation elements.

28. The fractal antenna for a vehicle as set forth in claim 27, wherein the fractal antenna is operated in a DMB broadcast reception band or an AM/FM broadcast reception band based on the total length of the patterns, which form the first and second radiation elements.

29. The fractal antenna for a vehicle as set forth in claim 26, wherein the first and second radiation elements are formed so as to be curved in a meander line structure when the lengths of fractal structure patterns, which form the first and second radiation elements, are longer than respective lengths of the first and the second substrates.
